(19) United States
(12) Patent Application Publication
(10) Pub. No.: US 2008/0241477 A1
(43) Pub. Date: Oct. 2, 2008

(54) Embossing of Flexible Sheet Material

(76) Inventors: Chris T. Edgar, Oakville (CA); Jason Robinson, Ancaster (CA)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/090,178

(22) PCT Filed: Oct. 12, 2006
(86) PCT No.: PCT/CA06/01690

§ 371 Date: Apr. 14, 2008

(30) Foreign Application Priority Data
Oct. 12, 2005 (US) 60726067

(51) Int. Cl. B32B 3/00; B29C 59/02

(52) U.S. Cl. 428/156; 264/293

(57) ABSTRACT

The present invention includes the application of heat and pressure to a flexible sheet: material, preferably a natural or synthetic animal hide, over a duration of time. A flexible sheet material having a raised design permanently embossed therein includes capturing the flexible sheet material between mating die halves, each die half having either a relief inverse negative of the raised design formed therein, a portion of the raised design having a height out of the plane of the flexible sheet material of an amount greater than or equal to the thickness of the flexible sheet material, and applying heat and pressure to the flexible sheet material through the die halves for a dwell period sufficient to emboss the design into the flexible sheet material. Optionally, the cavity beneath the raised design is back-filled with a flexible solid material. Also provided according to the present invention is an article produced according to the method described herein.

### BACKGROUND OF THE INVENTION

1. Field of Invention

The invention relates to the field of goods manufactured from flexible sheet material, and more specifically to a method and an article manufactured by this method comprising a raised design embossed onto a natural or synthetic animal hide.

2. Description of Related Art

Articles made from animal hide, or leather, are desirable for, among other reasons, durability, texture, and practicality. Additionally, clothing and accessories incorporating leather are often considered fashionable. In order to enhance the appearance of leather goods, many methods exist to integrally incorporate indicia into the leather. For example, U.S. Pat. No. 4,144,594 to Chapman discloses a leather belt having openings punched in it corresponding to the desired indicia. A backing is applied to the leather belt to contrast the openings with the remaining leather.

U.S. Pat. No. 4,319,523 discloses a leather embossing method and embossed article. According to this patent, indicia are pressed into the leather. This method has certain drawbacks, however. In the first instance, the indicia are sunken into the leather. Further, the depth of impression is limited to some fraction of the thickness of the leather itself. Each of these drawbacks limits the impact of the indicia applied.

On the other hand, it is desirable to provide a natural or synthetic leather article having dynamic raised indicia having a three-dimensional appearance integrally formed with the natural or synthetic leather.

### BRIEF SUMMARY OF THE INVENTION

In order to overcome these and other drawback of the prior art, provided according to the present invention is a method of forming a flexible sheet material having a raised design permanently embossed therein, including capturing the flexible sheet material between mating die halves, each die half having either a relief inverse negative of the raised design or a raised facsimile of the raised design, respectively, formed therein. The raised design has maximum height out of the plane of the flexible sheet material by an amount greater than or equal to the thickness of the flexible sheet material, and applying sufficient heat and pressure to the flexible sheet material through the die halves for a sufficient amount of time to emboss the design on the flexible sheet material, before releasing the flexible sheet material from the die halves. Optionally, the cavity beneath the raised design in the flexible sheet material is back-filled with a flexible solid material. Also provided according to the present invention is an article produced according to the method.

### BRIEF DESCRIPTION OF THE DRAWINGS

These and other features, advantages and benefits of the present invention will be made apparent with reference to the following descriptions and drawings, wherein:

FIG. 1 illustrates a plan view of an exemplary embodiment of the article of manufacture according to the present invention;

FIG. 2 illustrates a cross-sectional view of the article taken along line 2-2 of FIG. 1; and

FIG. 3 illustrates a perspective view of a negative mold half according to the present invention; and

FIG. 4 illustrates a perspective view of a negative mold half according to the present invention from a different position than FIG. 3.

### DETAILED DESCRIPTION OF THE INVENTION

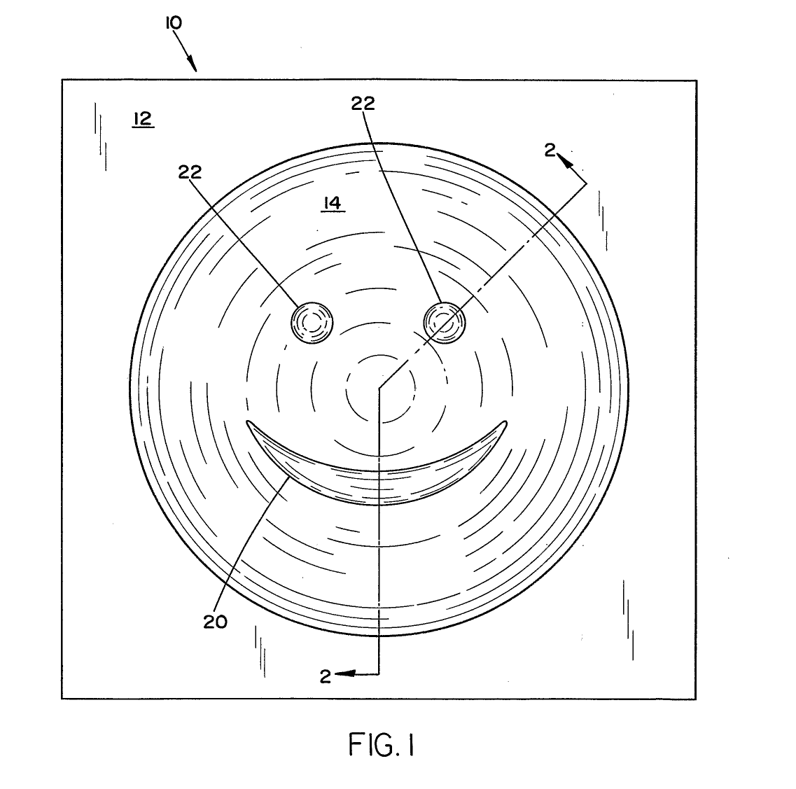

Referring now to FIG. 1, shown is an article of manufacture, generally 10, according to an exemplary embodiment of the present invention. The article 10 of manufacture includes a raised design 14 embossed into a flexible sheet material 12. The raised design 14 can be any shape or symbol desired to be embossed onto the flexible sheet material 12, and can include, without limitation, letters, numbers, logos, shapes, symbols, pictures or any combination thereof. The flexible sheet material 12 is preferably a natural or synthetic animal hide. Examples of acceptable base materials include, without limitation, leather goods, such as fashion leather in weights from about 0.5 to 1.0 oz., lamb leather of about 1.0 oz. weight, calf or cow leather of about 2 oz. to about 3 oz. weight, and synthetic coskin or pleather materials of comparable thickness, and the like.

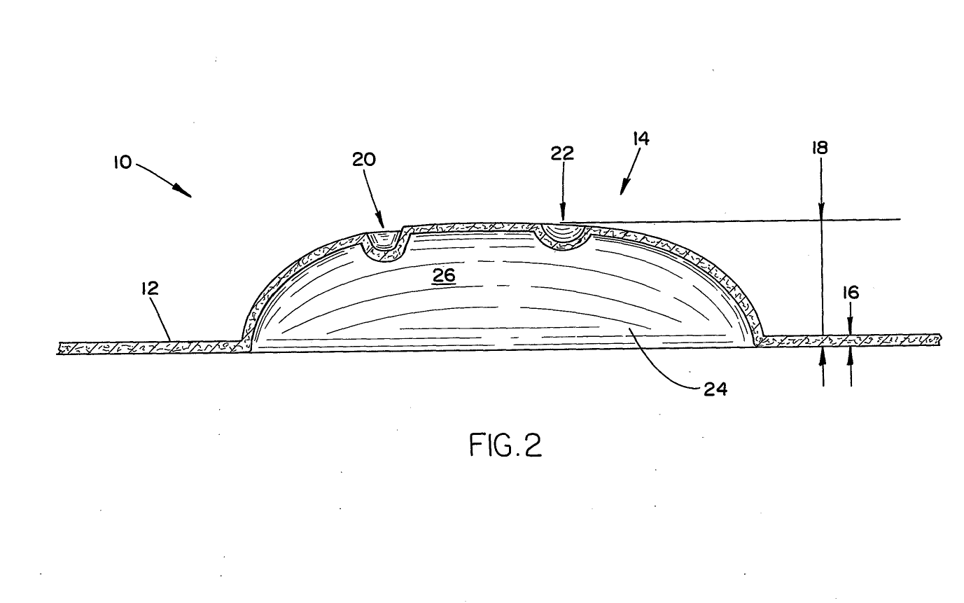

A predetermined raised design 14 to be embossed on the flexible sheet material 12 is arbitrarily selected. It is desired that the raised design 14 have a three-dimensional appearance. In order to take full advantage of the present invention, the raised design 14 will vary in height from the plane of the flexible sheet material 12, preferably, wherein the height of at least a portion of the raised design 14 is at least the thickness 16 (see, FIG. 2) of the flexible sheet material 12.

FIG. 2 illustrates a cross-section of the article 10 taken along section line 2-2 of FIG. 1. The flexible sheet material 12 has some thickness 16. The raised design 14 has a maximum height 18 that is out of the plane of the flexible sheet material 12 by a distance equal to or greater than the thickness 16. Preferably the raised design 14 will include certain relief features 20, 22 to define or enhance the three-dimensional appearance of the raised design 14. Optionally, the article 10 includes a back-fill 24 occupying some or all of the cavity 26 beneath the raised design 14. Back fill 24 is preferably a flexible material more preferably a rubber or silicon based material.

According to the present invention, the article 10 is formed by a pressing process that will now be described. Having chosen a raised design 14, a two-part die is prepared having two halves, each half bearing a either a positive (raised) or negative (relief) of the design 14. The two die halves should be complementary, with the raised image of the design 14 on the positive half corresponding to the sunken image of the design 14 in the negative half.

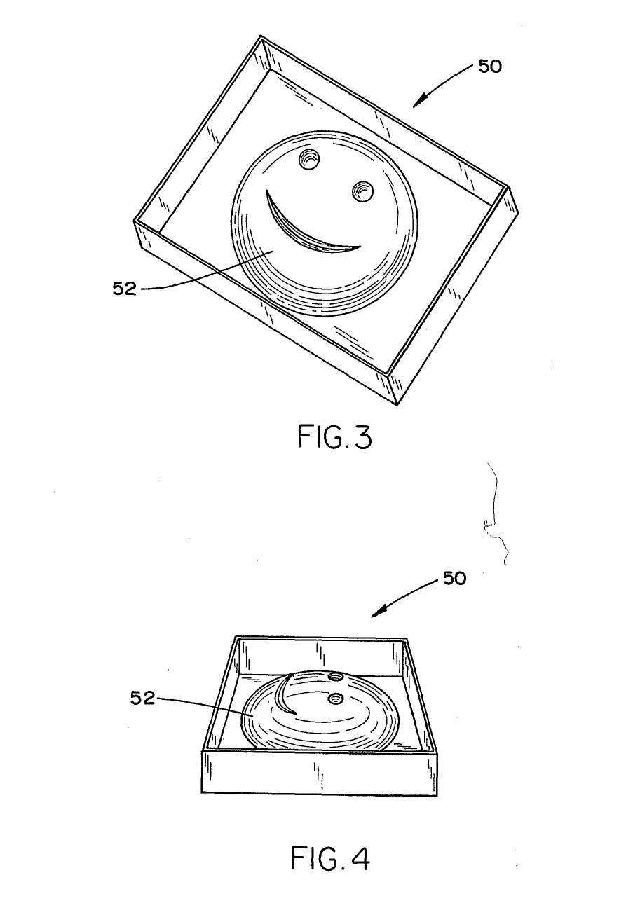

A variety of methods are known in the art for such die making, including manual forming, cast molding, injection molding, etc. A preferred method, according to the present invention, includes forming a negative relief portion of the two-part die in a stock material. The negative die half should preferably have at least a metal surface, or alternately may be metal throughout, as will be apparent, infra. More preferably, the features of the raised design 14 are input into a computer-controlled material forming machine, for example a CNC milling machine, which automates the process with great precision and accuracy. The CNC milling machine removes material from the selected stock according to the features of the raised design 14, thereby forming a negative die half 50 (see FIGS. 3, 4) bearing an inverse relief image 52 of the raised design 14, whereby the depression on the negative die half 50 corresponds to the relief image and height thereof on the positive die.

Referring now to FIGS. 3 and 4, illustrated are perspective views of a negative die half 50. Only the lower and side surfaces of the negative die half 50 are shown for the ease of illustration, although it will be understood that the negative die half 50 can and often will be thicker for use in pressing. FIGS. 3 and 4 each show the inverse relief image 52 of the raised design 14.

The corresponding positive die counterpart can be similarly machined. Alternately, the positive die can be formed by taking an impression of the negative die. For example, a border may be installed surrounding the negative die, and optionally a de-mold release chemical, such as stearic acid, EVIROSHIELD or WATERSHIELD brand release agents from Zyvax, Inc. of Boca Raton, Fla., UNIVERSAL MOLD RELEASE™ from Smooth-On company of Easton, Pa., or other mold release agent is applied to the negative relief die. A liquid casting material which is preferably acrylic or plaster based material known to the skilled artisan can then be introduced into the bordered negative die. An exemplary liquid casting material is sold under the brand name SMOOTHCAST®, with SMOOTHCAST® 320 material being suitable. Other plaster or acrylic based molding materials that are resistant to the temperatures required in the article embossing process may also be utilized. Once the material comprising the positive die has set, the two die halves can be separated, and prepared for embossing. Other manners of making an impression mold will be apparent to those skilled in the art in light of the present disclosure. However, a more precise impression mold of the negative die to form the positive die is facilitated with flowing materials that are allowed to solidify in the negative die.

The embossing method according to the present invention includes the application of heat and pressure under conditions sufficient to emboss the design onto the flexible material for some duration of time. The amount of heat, pressure and time is dependent upon various factors, such as the type of flexible material used, the type of design embossed thereon, the maximum height thereof, and the weight and thickness of the flexible material. Generally, however, the greater the heat and pressure the smaller is the amount of time required for the embossing process. As an exemplary manner of effecting embossing, the die halves may be fitted in a heat press machine. In addition to providing pressure to the flexible material, the heat press machine applies heat to the flexible sheet material 12. Preferably, at least one half of the die has at least a metal surface, as described above, to assist in conducting heat to the flexible sheet material 12. On the other hand, although it may be optionally present, the complementary half of the die need not be metal. This has the effect of avoiding direct heat to the corresponding side of the flexible sheet material 12, if desired.

According to the present method, the heat press applies a temperature of preferably between about 100 to about 400° C., depending on the type of material being embossed, and increasing within that range as the weight and thickness of the flexible sheet material 12 increases. For the range of exemplary materials disclosed herein and tabulated hereinbelow, the pressure applied can be up to about 150 PSI, but it will increase with thickness of the flexible sheet material 12 and with the increase of the maximum height of the raised design 14 relative to the thickness 16 of the flexible sheet material 12.

The flexible sheet material is held between the die halves for a dwell time sufficient to fix the raised design 14 in the flexible sheet material 12. The dwell time is selected based upon the properties of the particular flexible sheet material 12, including among these its weight and thickness, and the features of the raised design 14, among these its height and complexity. For the range of exemplary materials disclosed herein and tabulated hereinbelow, the dwell time in the press can be up to about 60 seconds, and increases with the weight and thickness of the flexible sheet material 12, and also with the maximum height 18 and detail of the raised design 14. The particular parameters will vary with the individual design, and the particular flexible sheet material 12 chosen. The following chart gives a range of temperature, pressure and time exemplary of certain sample materials.

| | | | Fashion | | Fashion | | |
|---|---|---|---|---|---|---|---|
| | Leather | Leather | Leather | Lamb | Leather | Coskin | Pleather |
| | (2 oz.) | (3 oz.) | (1 oz.) | (1 oz.) | (0.5 oz.) | Synthetic | Synthetic |
| Temp. | 150-350 | 250-320 | 150-280 | 150-280 | 150-260 | 100-200 | 110-220 |
| (° C.) | | | | | | | |
| Pressure | 20-120 | 20-120 | 20-100 | 20-100 | 20-75 | 40-140 | 40-140 |
| (PSI) | | | | | | | |
| Dwell | 4-40 | 4-40 | 4-25 | 4-25 | 4-20 | 5-20 | 5-20 |
| (Sec.) | | | | | | | |

More preferably, the heat press machine is automated and programmable. This facilitates the entire process and certain additional method steps. A programmable press may be set to store the parameters of a particular design mold, and to facilitate later production from a previous mold. Alternately or additionally, irrespective of whether the heat press is manually operated or automated, the pressure applied may be increased during the press cycle. This has the advantage of avoiding possible tearing of the flexible sheet material 12, and also of improving the sharpness of detail in the raised design 14 in the final article 10.

The article 10, per se, is complete upon the conclusion of the press cycle. Optionally, an additional step may be performed to extend the permanence and durability of the raised design 14. A back-fill 24 material can be introduced into the cavity 26 formed beneath the raised design 14. Preferably, back-fill 24 comprises a flexible solid compound. Thereby, the raised design 14 would better retain its shape, yet remain flexible to move with the outlying flexible sheet material 12. In a more preferred embodiment, back-fill 24 comprises a liquid rubber or silicone based material, which is allowed to set to a solid. In another embodiment, back-fill 24 comprises a flexible rubbery foam type material or silicone foam type material which is allowed to set to a solid. Preferably, back fill 24 is introduced into the (inverted) cavity 26 in a liquid state and permitted to solidify in the shape of the cavity 26.

Optionally, the raised design 14 and/or the surrounding flexible sheet material 12 can be treated for color or texture to highlight or enhance its appearance. Flexible sheet material 12 may be stained, colored or printed across the entire material prior to undergoing the press cycle or after. Texture modification to the flexible sheet material 12, as by stamping, pressing, rolling or steaming, may be applied across the entire material before the press cycle. Preferably, if texture modification is applied after the press cycle, it is applied outside the area of raised design 14, so as not to detract from it.

The present invention has been described with regard to certain exemplary and/or preferred embodiments. These embodiments are meant as merely illustrative, and not limiting, on the scope of the claimed invention, which is construed solely with reference to following appended claims.

1. An article of manufacture comprising a flexible sheet material having a raised design permanently embossed therein, wherein at least a portion of the raised design has a height out of the plane of the flexible sheet material of an amount greater than or equal to the thickness of the flexible sheet material, the raised design being formed by the application of heat and pressure to the flexible sheet material between mating die halves, each die half having one of a relief negative inverse or a raised facsimile of the raised design, respectively.

2. The article according to claim 1, wherein the flexible sheet material comprises natural or synthetic leather.

3. The article according to claim 1, the article further comprising a flexible solid material back-filled into the cavity beneath the raised design.

4. The article according to claim 1, wherein heat is applied to the flexible sheet material via one of the die halves, which comprises a metal surface.

5. The article according to claim 1, wherein one of the die halves comprises a non-metal surface.

6. The article according to claim 1, further comprising color or texture enhancements applied to the article.

7. A method of forming a flexible sheet material having a raised design permanently formed therein, the method comprising:
(a) capturing the flexible sheet material between mating die halves, each die half having one of a relief negative inverse image of the raised design or a raised facsimile of the raised design, respectively, formed therein, at least a portion of the raised design having a height at least greater than or equal to the thickness of the flexible sheet material;
(b) applying heat and pressure to the flexible sheet material through the die halves for a period sufficient to fix the raised design in the flexible sheet material, and
(c) releasing the article from the die halves.

8. The method according to claim 7, further comprising
(d) back-filling the cavity beneath the raised design in the flexible sheet material with a flexible solid material.

9. The method according to claim 7, wherein at least one mold half comprises a metal material for conducting heat to the flexible sheet material.

10. The method according to claim 9, wherein the mold half having a relief negative image of the raised design comprises a metal material.

11. The method according to claim 7, wherein at least one mold half comprises a non-metal material.

12. The method according to claim 11, wherein the mold half having a raised facsimile of the raised design comprises a non-metal material.

13. The method according to claim 7, wherein the mold half having a raised facsimile of the raised design is formed by making an impression of the mold half having the relief negative image of the raised design.

14. The method according to claim 7, wherein applying heat comprises applying a temperature of between about 100 and about 400 degrees Celsius.

15. The method according to claim 7, wherein applying pressure comprises applying between about 20 and about 150 pounds per square inch.

16. The method according to claim 7, wherein the dwell period is between about 4 and about 60 seconds.

17. The method according to claim 7, wherein the pressure applied varies over the dwell period.

18. The method according to claim 17, wherein the pressure applied increases over the dwell period.

19. The method according to claim 7, further comprising
(d) applying color or texture enhancements to the flexible sheet material.

20. The article made according to the process of claim 7.

21. The method according to claim 7, wherein the flexible sheet material comprises a natural or synthetic leather.
